(19) United States
(12) Patent Application Publication
(10) Pub. No.: US 2005/0157500 A1
(43) Pub. Date: Jul. 21, 2005

(54) Illumination apparatus with laser emitting diode

(76) Inventors: Wen-Ho Chen, Hsin Chu City (TW); Hui Yen Huang, Hsin Chu City (TW); King Chang Chang, Hsin Chu City (TW); Chia-Feng Lin, Tai Chung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/760,416

(22) Filed: Jan. 21, 2004

(51) Int. Cl. F21V 29/00

(52) U.S. Cl. 362/294; 362/800; 362/545; 362/218

(57) ABSTRACT

An illumination apparatus has a frame with a plurality of fins, at least one thermally conductive sheet and at least one illumination module. The illumination modules are positioned on the frame, and the thermally conductive sheets are positioned between the frame and the illumination modules. Thus, the illumination modules generate light beams and heat, which is carried away by the frame with a plurality of fins.

### BACKGROUND OF THE INVENTION

1. Field of the Invention

The present invention relates to an illumination apparatus, and in particular to an illumination apparatus with laser emitting diodes that are used as a light source.

2. Description of Related Art

Referring to FIG. 1, a cold cathode fluorescent lamp (CCFL) 41a is implemented in the conventional liquid crystal display as a backlight. The CCFL 41a is positioned near a light guide plate 10a, and a reflective sheet 20a is attached to the bottom surface of the light guide plate 10a. A receiving space 21a is integrally formed with the reflective sheet 20a and is positioned near the light guide plate 10a. An opening of the receiving space 21a is oriented toward the light guide plate 10a so that the CCFL 41a is positioned within the receiving space 21a by rubber 50a. Thus, the receiving space 21a of the reflective sheet 20a is used as a reflective surface, and light beams of the CCFL 21a will be reflected by the receiving space 21a and directed toward the opening of the receiving space 21a and the light guide plate 10a.

However, there are some shortcomings when the CCFL is implemented in the liquid crystal display, described as follows.

1. The CCFL usually contains 2-8 mg of mercury, which is not environmentally friendly.

2. The CCFL is activated by a high electrical voltage so that it is likely for users to get electrical shock. It usually takes 3-5 minutes for the CCFL to reach the optimal operating temperature, and this time is dependent on the surroundings temperature.

3. The CCFL is made from glass-like material, and it's possible for the CCFL to be shattered or broken.

4. Electrodes of the CCFL are connected with electrical wires by soldering, thereby causing the cost of manufacturing to be higher.

Thus, there is need to develop an illumination module with a laser emitting diode used as a light source.

### SUMMARY OF THE DISCLOSURE

It is an object of the present invention to provide an illumination apparatus with laser emitting diodes that are used as a light source.

It is an object of the present invention to provide an illumination apparatus with laser emitting diodes. The illumination apparatus has a frame with a plurality of fins, at least one thermally conductive sheet and at least one laser emitting diode. The frame with a plurality of fins also has a receiving space, and the thermally conductive sheet is attached to the inner surface of the receiving space of the frame. The laser emitting diodes correspond to the receiving space of the frame and are attached to the thermally conductive sheet.

### BRIEF DESCRIPTION OF DRAWINGS

The present invention can be fully understood from the following detailed description and preferred embodiment with reference to the accompanying drawings in which:

FIG. 1 is a cross-sectional partial view of a backlight configuration of a conventional liquid crystal display;

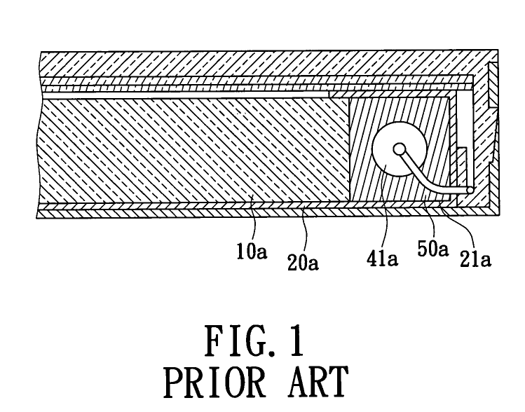

FIG. 2 is an exploded view of an illumination module in accordance with one embodiment of the present invention;

FIG. 3 is a perspective view of an illumination apparatus in accordance with one embodiment of the present invention;

FIG. 4 is a cross-sectional view of the illumination apparatus of FIG. 3;

FIGS. 5 and 6 are perspective views of the illumination apparatus of FIG. 3;

FIG. 7 is a cross-sectional partial view of a backlight configuration of the liquid crystal display using the illumination apparatus in accordance with the present invention; and

FIG. 8 is an enlarged cross-sectional view of the illumination apparatus in accordance with another embodiment of the present invention.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

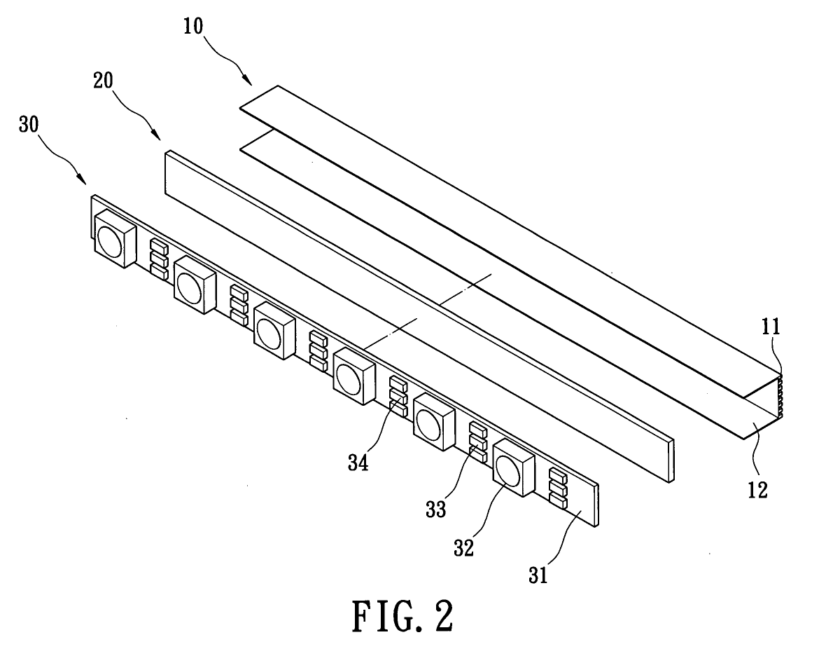

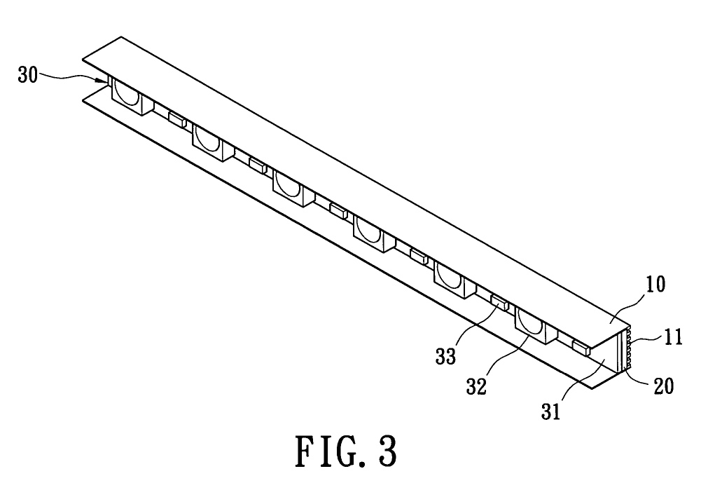

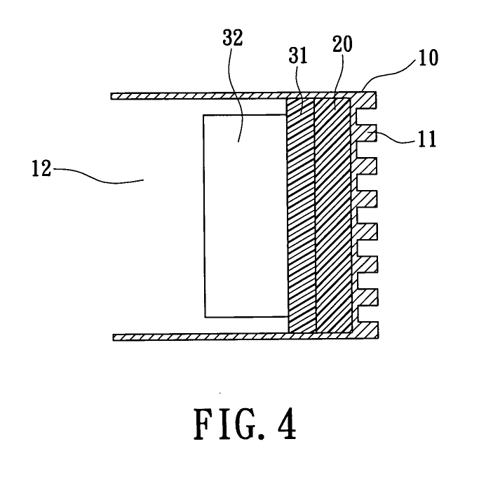

FIGS. 2-6 illustrate one embodiment of an illumination apparatus in accordance with of the present invention. Referring to FIGS. 2-4, the illumination apparatus has a frame 10, a thermally conductive sheet 20 and an illumination module 30. The thermally conductive sheet 20 is soft and attached to one of the inner surfaces of the frame 10. A plurality of fins 11 are integrally formed with the frame 10. The illumination module 30 corresponds to and is attached to the thermally conductive sheet 20. Then, the illumination module 30 is fixedly positioned at the inner surface of the frame 10 by the thermally conductive sheet 20. Further referring to FIG. 3, the illumination module 30 generates light beams, which are reflected by the inner surfaces of the frame 10 so that light beams are directed toward an opening of the frame 10. In addition, referring to FIG. 4, heat is generated by the illumination module 30 and conducted to the frame 10. Thus, the frame 10 carries heat into the fins 11 so that heat is vented to the surroundings.

Further referring to FIGS. 2-4, the illumination module 30 has a strip-shaped printed circuit board (PCB) 31, a plurality of light emitting diodes 32, a plurality of electrical resistances 33 and a plurality of control ICs 34. The PCB 31 can be soft, and the light emitting diodes 32, the electrical resistances 33 and the control ICs 34 are electrically connected to one side surface of the PCB 31. The frame 10 can be made from, but is not limited to, aluminum or copper. In addition, the frame 10 can be strip-shaped and its cross-sectional view is U-shaped in accordance with the present invention. As described above, the fins 11 are integrally formed with the frame 10.

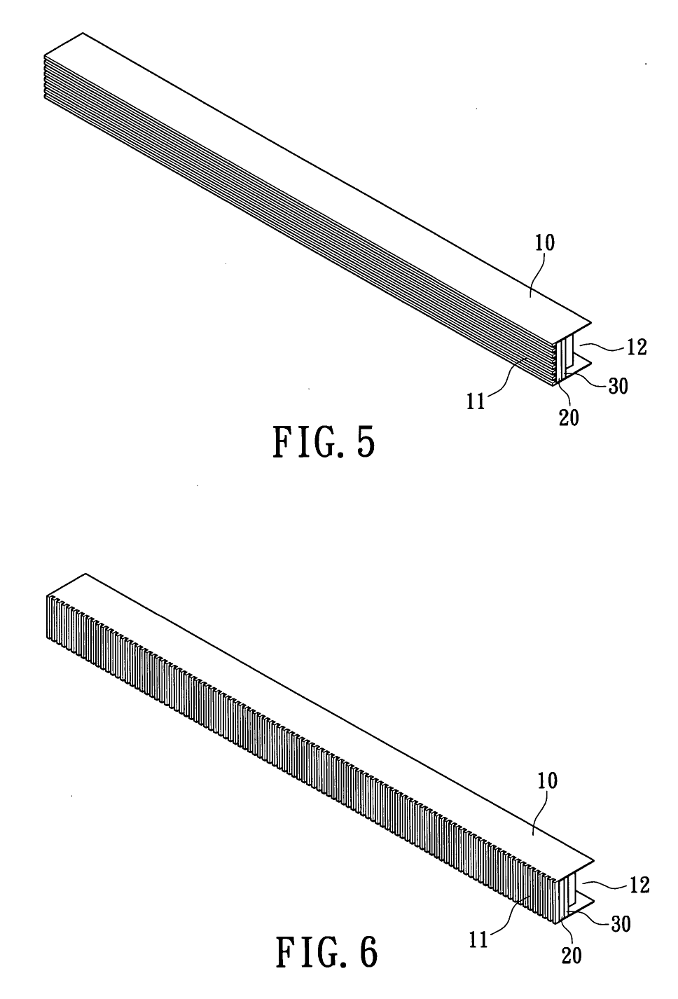

As shown in FIGS. 5 and 6, the fins 11 are longitudinally or traversely positioned with respect to the frame 10. The frame 10 has a receiving space 12, and the thermally conductive sheet 20 is attached to the inner surface of the frame 10. One side surface of the PCB 31 is attached to the thermally conductive sheet 20. In this regard, when the PCB 31 is supplied with electrical power and the light emitting diodes 32 are activated, heat generated by the light emitting diodes 32 is uniformly conducted into the frame 10. Then, heat is vented to the surroundings by the fins 11, thereby cooling the light emitting diodes 32. Illumination efficiency and life expectancy of the light emitting diodes 32 can be enhanced or increased. In addition, the fins 11 significantly increase the cooling area of the frame 10 so that heat can be efficiently dissipated.

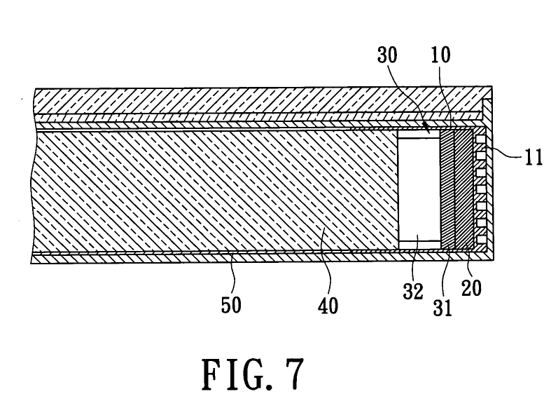

Referring to FIG. 7, the illumination apparatus of the present invention is implemented in a backlight configuration of a liquid crystal display. The illumination apparatus is positioned near the light guide plate 40 so that the light beams from the illumination module 30 are directed toward the opening of the frame 10 by a reflective sheet 40. In addition, it significantly increases performance of light emitting diodes 32, and the light emitting diodes 32 is more environmentally friendly than the CCFL and needs a lower drive voltage. Thus, it is much safer when the light emitting diodes 32 are implemented in the liquid crystal display. Additionally, less time is needed to heat the light emitting diodes 32 to an optimal temperature. Further, the light emitting diodes 32, electrical resistances 33 and control ICs 34 are placed and mounted on the PCB by SMT assembly techniques. Thus, component placement can be completed by automation metrology. Color rendering index of the light emitting diodes 32 is 30% better than that of the CCFL, and the light emitting diodes 32 also have a widespread range of hues. Above all, compared with the CCFL, the light emitting diodes 32 are not susceptible to breaking or shattering. The light emitting diodes 32 are much more reliable when they are in use.

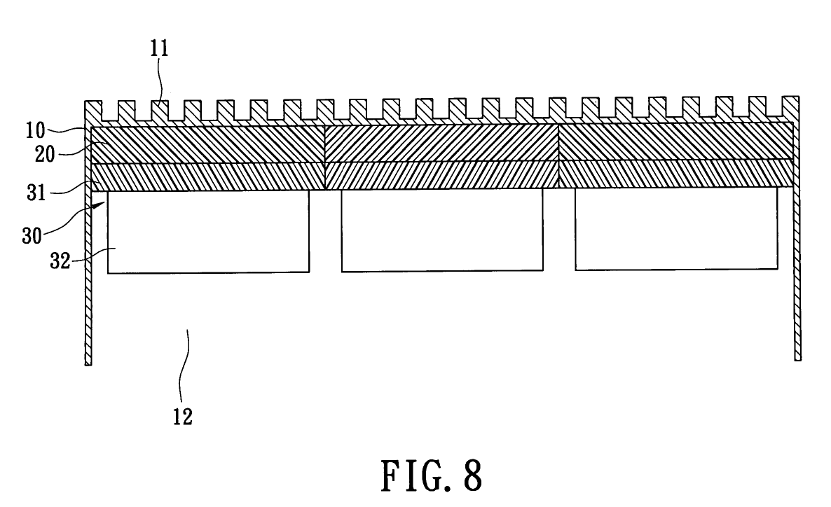

FIG. 8 illustrates another embodiment of illumination apparatus in accordance with the present invention. Referring to FIG. 8, each of the illumination modules 30 has the light emitting diode 32 and its corresponding PCB 31. Each of the illumination modules 30 is attached to corresponding thermally conductive sheet 20, and then the illumination modules 30 are positioned on the frame 10 by their corresponding thermally conductive sheets 20. In this regard, each of the light emitting diodes 32 is used as a light source and generates heat. Heat is uniformly carried away and efficiently dissipated by the thermally conductive sheet 20 and the frame 10. Then, heat is carried away to the fins 11 and dissipated to the surroundings.

While the invention has been described with reference to the preferred embodiments, the description is not intended to be construed in a limiting sense. It is therefore contemplated that the appended claims will cover any such modifications or embodiments as may fall within the scope of the invention defined by the following claims and their equivalents.

1. An illumination apparatus, comprising:
a frame, having a plurality of fins and a receiving space;
at least one thermally conductive sheet, attached to an inner surface of the receiving space of the frame; and
at least one illumination module, attached to the corresponding thermally conductive sheets positioned on the frame.

2. The illumination apparatus as claimed in claim 1, wherein the illumination module comprises:
a strip-shaped printed circuit board; and
a plurality of light emitting diodes, electrically connected to the printed circuit board.

3. The illumination apparatus as claimed in claim 2, further comprising a plurality of electrical resistances positioned on the printed circuit board.

4. The illumination apparatus as claimed in claim 2, further comprising a plurality of control ICs positioned on the printed circuit board.

5. The illumination apparatus as claimed in claim 2, wherein the printed circuit board is soft.

6. The illumination apparatus as claimed in claim 1, wherein the fins are positioned on an outer surface of the frame.

7. The illumination apparatus as claimed in claim 1, wherein a cross section of the frame is U-shaped.

8. The illumination apparatus as claimed in claim 1, wherein the fins are positioned on an outer surface of the frame and are longitudinally positioned with respect to the frame.

9. The illumination apparatus as claimed in claim 1, wherein the fins are positioned on an outer surface of the frame and the fins 11 are traversely positioned with respect to the frame.

10. The illumination apparatus as claimed in claim 1, wherein the frame is made of aluminum or copper.
